(19) United States
(12) Patent Application Publication
(10) Pub. No.: US 2024/0034183 A1
(43) Pub. Date: Feb. 1, 2024

(54) Power Sharing System and Method of Vehicle

(71) Applicants: Hyundai Motor Company, Seoul (KR); Kia Corporation, Seoul (KR)

(72) Inventors: Wan Jae Shin, Yongin-si (KR); Sung Geun Park, Yongin-si (KR); Jung Woo Lim, Paju-si (KR)

(21) Appl. No.: 18/062,431

(22) Filed: Dec. 6, 2022

(30) Foreign Application Priority Data
Jul. 26, 2022 (KR) 10-2022-0092537

(51) Int. Cl. B60L 53/66; B60L 53/18; B60L 53/50; B60L 53/68; G06Q 30/04

(52) U.S. Cl. CPC B60L 53/665; B60L 53/18; B60L 53/50; B60L 53/68; G06Q 30/04

(57) ABSTRACT

An embodiment power sharing method of a vehicle includes electrically connecting the vehicle to an external charger, determining whether a second vehicle connected to a power output terminal of the vehicle via a cable is an authenticated vehicle, in response to a determination that the second vehicle is an authenticated vehicle, transmitting a request for the second vehicle to a server, receiving a response to the request from the server, charging power to the second vehicle, and communicating information with the server or the second vehicle, the information related to the power charged to the vehicle and the second vehicle.

### CROSS-REFERENCE TO RELATED APPLICATIONS

This application claims the benefit of Korean Patent Application No. 10-2022-0092537, filed on Jul. 26, 2022, which application is hereby incorporated herein by reference.

### TECHNICAL FIELD

The present invention relates to a power sharing system and method of a vehicle.

### BACKGROUND

Although the global market environment and government-led electric vehicle dissemination are growing quantitatively, there is still a lack of charging infrastructure which causes various problems. For example, it may occur, in a parking lot where electric vehicle chargers are installed, that a vehicle requiring a relatively short time to fully charge the battery, such as a Plug in Hybrid Electric Vehicle (PHEV) or a small commercial electric vehicle, occupies a charger for a long time so as to cause various problems such as conflicts among residents due to the inconvenience of not being able to charge their vehicle. Particularly, in a situation where internal combustion engine vehicles are expected to be discontinued after 2030, there is a limit to securing a facility for charging the vehicles parked in residential area-parking spaces.

Meanwhile, in China where the number of vehicles per capita increases by more than 10% every year and the ratio of parking spaces to vehicles shows 1:0.8 in large cities and 1:0.5 in small and medium sized cities, a policy was implemented to issue registration plates preferentially to electric vehicles in order to mitigate the significant lack of parking space. Although this policy is rapidly increasing the penetration rate of electric vehicles, the charging infrastructure is insufficient.

In addition, in the case of a household that operates two or more electric vehicles but has only one charger, in order to charge two electric vehicles, the two electric vehicles have to be parked alternately in a parking lot equipped with the electric vehicle charger, resulting in charging inconvenience.

Such an inconvenience also occurs to fleet operators such as electric vehicle taxi operators, rental operators, government vehicle operators (such as post offices/public offices), and many business electric vehicle operators that have to repeat, in order to charge a large number of electric vehicles one by one with a small number of electric vehicle chargers, driving the vehicles to the chargers, charging the vehicles, checking out completion of charging, and moving the charged vehicles out of the charger.

There is therefore a need of a technology capable of simultaneously charging a plurality of electric vehicles by sharing electric power of a vehicle in this technical field.

### SUMMARY

The present invention relates to a power sharing system and method of a vehicle. Particular embodiments relate to a service system for sharing power supplied from an eco-friendly vehicle charger with another vehicle and a method for providing the corresponding service.

An embodiment of the present invention provides a vehicle power sharing system and method that is capable of achieving a lock-in effect by expanding the function of an electric vehicle.

Another embodiment of the present invention provides a vehicle power sharing system and method that is capable of simultaneously charging a plurality of vehicles more in number than the chargers installed in an apartment complex or shopping mall of a large city with an underdeveloped charging infrastructure environment.

Another embodiment of the present invention provides a power sharing system and method that is capable of contributing to the promotion of a personal electric power transaction and the creation of a new business model of a parking/charging service.

Another embodiment of the present invention provides a power sharing system and method that is capable of increasing demand for eco-friendly vehicles and contributing to society by sharing battery charging terminals.

The embodiments of the present invention are not limited to the aforesaid, and other embodiments not described herein with be clearly understood by those skilled in the art from the descriptions below.

The power sharing method of the vehicle according to an embodiment of the present invention includes connecting, electrically, to an external charger, determining whether another vehicle connected to a power output terminal via a cable is an authenticated vehicle, transmitting, when the another vehicle is an authenticated vehicle, a prepayment request for the another vehicle to a server, and receiving a response thereto from the server, charging power to the another vehicle, and communicating information with the server or the another vehicle to settle costs of power charged to the vehicle and the another vehicle.

Here, communicating information with the server or the another vehicle may include transmitting charged power amount information of the vehicle and the another vehicle to the server, receiving charged power cost information of the vehicle from the server, and transmitting charged power cost payment information of the vehicle to the server.

Here, communicating information with the server or the another vehicle may include transmitting charged power amount information of the vehicle and the another vehicle to the server, receiving charged power cost information of the vehicle and the another vehicle from the server, and transmitting charged power cost payment information of the vehicle and the another vehicle to the server.

Here, communicating information with the server or the another vehicle may include receiving deposit payment information from the another vehicle, transmitting charged power amount information of the vehicle and the another vehicle to the server, receiving charged power cost information of the vehicle and the another vehicle from the server, transmitting refund payment information to the another vehicle, and transmitting charged power cost payment information of the vehicle and the another vehicle to the server.

Here, the costs of the powers charged to the vehicle and the another vehicle may be determined at different rates.

Here, determining whether the another vehicle is an authenticated vehicle may include determining whether the another vehicle is an authenticated vehicle based on whether the vehicle is subscribed to a platform of a charging service provider or whether the vehicle is capable of using a charging service.

Here, the power sharing method of the vehicle may further include entering a vehicle wheel drive lock mode before charging the another vehicle and releasing the vehicle wheel drive lock mode after charging the another vehicle is finished.

Here, the power sharing method of the vehicle may further include receiving from a user whether to permit charging the another vehicle and an allowed charging time, determining whether the another vehicle is currently permitted for charging, and unlocking, when the another vehicle is currently permitted for charging, a power output terminal cover, and displaying that the vehicle is currently in a chargeable state.

Here, the power sharing method of the vehicle may further include setting off, when the another vehicle is not an authenticated vehicle, a warning alarm and stopping power sharing.

Here, the power sharing method of the vehicle may further include determining whether a power input terminal cable connected to a charging station is disconnected or a charging stop command is received from a user terminal, stopping, when the power input terminal cable is disconnected or the charging stop command is received, charging the another vehicle, determining whether to resume charging the another vehicle, and resuming or ending charging according to a result of determination on whether resumption of charging the another vehicle is approved.

Also, the vehicle for sharing power from an external charger with another vehicle according to an embodiment of the present invention includes a processor for determining whether the another vehicle connected to a power output terminal via a cable is an authenticated vehicle and charging the another vehicle and a communication unit for transmitting, when the another vehicle is an authenticated vehicle, to a server a payment request for a deposit for power charging of the connected vehicle, receiving a response thereto from the server, and communicating information with the server or the another vehicle to settle costs of power charged to the vehicle and the another vehicle.

Here, the communication unit may transmit charged power amount information of the vehicle and the another vehicle to the server, receive charged power cost information of the vehicle from the server, and transmit charged power cost payment information of the vehicle to the server.

Here, the communication unit may transmit charged power amount information of the vehicle and the another vehicle to the server, receive charged power cost information of the vehicle and the another vehicle from the server, and transmit charged power cost payment information of the vehicle and the another vehicle to the server.

Here, the communication unit may receive deposit payment information from the another vehicle, transmit charged power amount information of the vehicle and the another vehicle to the server, receive charged power cost information of the vehicle and the another vehicle from the server, transmit refund payment information to the another vehicle, and transmit charged power cost payment information of the vehicle and the another vehicle to the server.

Here, the costs of the powers charged to the vehicle and the another vehicle may be determined at different rates.

Here, the processor may determine whether the another vehicle is an authenticated vehicle based on whether the vehicle is subscribed to a platform of a charging service provider or whether the vehicle is capable of using a charging service.

Here, the processor may control the vehicle to enter a wheel drive lock mode before charging the another vehicle and release the vehicle wheel drive lock mode after charging the another vehicle is finished.

Here, the communication unit may receive from a user whether to permit charging of the another vehicle and an allowed charging time, and the processor may determine whether the another vehicle is currently permitted for charging and control, when the another vehicle is currently permitted for charging, to unlock a power output terminal cover and display that the vehicle is currently in a chargeable state.

Here, the processor may control, when the another vehicle is not an authenticated vehicle, the vehicle to set off a warning alarm and stop power sharing.

Here, the processor may control to determine whether a power input terminal cable connected to a charging station is disconnected or a charging stop command is received from a user, control, when the power input terminal cable is disconnected or the charging stop command is received, to stop charging the another vehicle, and resume or end charging according to a result of determination on whether resumption of charging the another vehicle is approved.

According to various embodiments of the present invention as described above, it may be possible to achieve the lock-in effect by expanding the function of the electric vehicle.

It may also be possible to simultaneously charge a plurality of vehicles greater in number than the chargers installed in an apartment complex or shopping mall of a large city with an underdeveloped charging infrastructure environment.

It may also be possible to contribute to the promotion of a personal power transaction and the creation of a new business model of a parking/charging service.

It may also be possible to increase the demand for eco-friendly vehicles to contribute to society by sharing battery charging terminals.

The advantages of embodiments of the present invention are not limited to the aforesaid, and other advantages not described herein may be clearly understood by those skilled in the art from the descriptions below.

### BRIEF DESCRIPTION OF THE DRAWINGS

FIG. 1 shows an example in which an eco-friendly vehicle charger, a first vehicle and a second vehicle are connected to each other for sharing power according to an embodiment of the present invention;

FIG. 2 shows a configuration of a master vehicle according to an embodiment of the present invention;

FIG. 3 is a flowchart illustrating an operation sequence of a server for registering a slave vehicle in a permitted vehicle list of a master vehicle in response to a user request in the master vehicle according to an embodiment of the present invention;

FIG. 4 is a flowchart illustrating an operation sequence of a server for registering a slave vehicle in a permitted vehicle list of a master vehicle in response to a user request of the slave vehicle according to an embodiment of the present invention;

FIG. 5 is a flowchart illustrating an operation sequence of a master vehicle for sharing charging power according to another embodiment of the present invention;

FIG. 6 illustrates an example in which charging power is shared according to an embodiment of the present invention;

FIG. 7 conceptually illustrates a method of billing a power charging cost according to an embodiment of the present invention;

FIG. 8 illustrates a signal transmission/reception operation sequence between a server and terminals for billing according to the embodiment of FIG. 7;

FIG. 9 conceptually illustrates a method of billing a power charging cost according to another embodiment of the present invention;

FIG. 10 illustrates a signal transmission/reception operation sequence between a server and terminals for billing according to the embodiment of FIG. 9;

FIG. 11 conceptually illustrates a method of billing a power charging cost according to another embodiment of the present invention;

FIG. 12 illustrates a signal transmission/reception operation sequence between a server and terminals for billing according to the embodiment of FIG. 11; and

FIG. 13 is a block diagram illustrating a power sharing system according to an embodiment of the present invention.

### DETAILED DESCRIPTION OF ILLUSTRATIVE EMBODIMENTS

Hereinafter, descriptions are made of the embodiments disclosed in the present specification with reference to the accompanying drawings in which the same reference numbers are assigned to refer to the same or like components and redundant description thereof is omitted. As used in the following description, the suffix “module” and “unit” are granted or used interchangeably in consideration of easiness of description but, by itself, having no distinct meaning or role. In addition, detailed descriptions of well-known technologies related to the embodiments disclosed in the present specification may be omitted to avoid obscuring the subject matter of the embodiments disclosed in the present specification. In addition, the accompanying drawings are only for easy understanding of the embodiments disclosed in the present specification and do not limit the technical sprit disclosed herein, and it should be understood that the embodiments include all changes, equivalents, and substitutes within the sprit and scope of the disclosure.

As used herein, terms including an ordinal number such as “first” and “second” can be used to describe various components without limiting the components. The terms are used only for distinguishing one component from another component.

It will be understood that when a component is referred to as being “connected to” or “coupled to” another component, it can be directly connected or coupled to the other component or an intervening component may be present. In contrast, when a component is referred to as being “directly connected to” or “directly coupled to” another component, there are no intervening components present.

As used herein, the singular forms are intended to include the plural forms as well, unless the context clearly indicates otherwise.

It will be further understood that the terms “comprises” or “has,” when used in this specification, specify the presence of a stated feature, number, step, operation, component, element, or a combination thereof, but they do not preclude the presence or addition of one or more other features, numbers, steps, operations, components, elements, or combinations thereof.

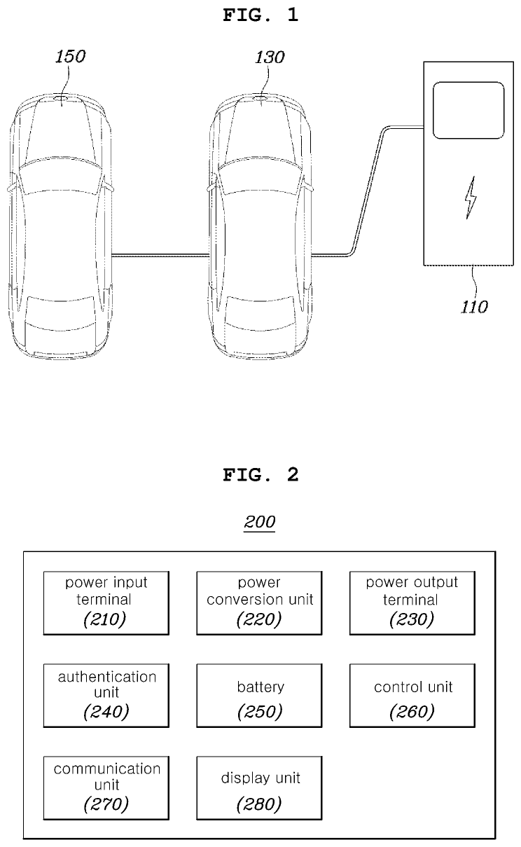

FIG. 1 shows an example in which an eco-friendly vehicle charger, a first vehicle, and a second vehicle are connected to each other for sharing power according to an embodiment of the present invention.

With reference to FIG. 1, the first vehicle 130 may be connected to the charger no via a charging cable for battery charging, and the second vehicle 150 may be connected to the first vehicle 130 via a charging cable for battery charging.

In this specification, a vehicle that shares power with other vehicles, such as the first vehicle 130, is defined as a master vehicle, and a vehicle that receives power from another vehicle, such as the second vehicle 150, is defined as a slave vehicle.

Meanwhile, in order to share power with the second vehicle iso, the first vehicle 130 has to be provided with a power-sharing function, for example, a power output terminal, a power converter and controller, a communication system, a power user authentication, and display system, etc.

Meanwhile, there may be four charging states in the connected state as shown in FIG. 1.
1) A state in which only the first vehicle 130 is being charged from the charger no (e.g., when the second vehicle 150 is fully charged).
2) A state in which the first vehicle 130 and the second vehicle 150 are being charged at the same time.
3) A state in which only the second vehicle 150 is being charged (e.g., when the first vehicle 130 is fully charged or when the first vehicle 130 supplies only to the second vehicle 150).
4) A state in which neither the first vehicle 130 nor the second vehicle 150 is being charged (both being fully charged).

At this time, although not shown in FIG. 1, if the second vehicle 150 has the power sharing function, the second vehicle 150 may allow power sharing for charging another vehicle while the second vehicle 150 is being charged.

FIG. 2 shows a configuration of a master vehicle 200 according to an embodiment of the present invention.

With reference to FIG. 2, the master vehicle 200 includes a power input terminal 210, a power conversion unit 220, a power output terminal 230, an authentication unit 240, a battery 250, a control unit 260, a communication unit 270, and a display unit 280.

The power input terminal 210 receives external power, i.e., power from a charger through a cable connection. Here, the power input terminal 210 may be configured to receive power in a way of using DC combo, CHAdeMO, 220V AC power, supercharger, destination charger, or the like. The power input terminal 210 may be freely positioned, and it may also be possible for a vehicle to be provided with a plurality of power input terminals. For example, the power input terminal 210 may be provided on the right C pillar of the vehicle.

The power conversion unit 220 may convert power input through the power input terminal 210 into power for charging the battery 250 or into power for charging another vehicle through the power output terminal 230. Meanwhile, the power conversion unit 220 may include a bypass function that is capable of splitting power input through the power input terminal 210 for charging another vehicle through the power output terminal 230 while charging the master vehicle 200 simultaneously.

The power output terminal 230 outputs power for charging another vehicle through cable connection. Here, the power output terminal 230 may be configured to output power in a way of using DC combo, CHAdeMO, 220V AC power, supercharger, destination charger, or the like. The power output terminal 230 may be freely positioned, and it may also be possible for a vehicle to be provided with a plurality of power output terminals. For example, the power output terminal 230 may be provided on the left C pillar of the vehicle to allowing charging power through the right C pillar of another vehicle parked side by side.

The authentication unit 240 provides authentication, billing, payment for use as a master vehicle or a slave vehicle, etc. The authentication unit 240 receives, for example, an input for whether or not to provide charging to another vehicle through the display unit 280. It may also be possible to store a list of vehicles permitted to be charged in an internal memory or a connected server.

There may be three authentication modes for permitting a master vehicle to supply power to a slave vehicle.

The first mode is to permit, upon connection of a cable to the power output terminal of the master vehicle, charging a slave vehicle without a separate permit procedure in an unauthenticated manner. In this case, the master vehicle may supply power to the slave vehicle for free without billing for charged power of the slave vehicle.

The second mode is to permit charging only of specific vehicles preregistered in a vehicle-specific permission manner. This may be useful for a household operating two or more electric vehicles (EVs). Here, the charging service platform of the master vehicle may be the same platform as the service platform provided by the charging infrastructure operator or may be a different service platform. Even in this case, the master vehicle may supply power to the slave vehicle for free without billing for charged power of the slave vehicle.

The third mode is to permit an unspecified vehicle to access the power output terminal of the master vehicle in an all-permissive manner. The slave vehicle must be subscribed to the charging service platform of the master vehicle. Here, the charging service platform of the master vehicle may be the same platform as the service platform provided by the charging infrastructure operator or may be a different service platform. Here, the charging service platform of the master vehicle may score the usage performance and power supplier evaluation as points in order to quantify the payment reliability of the power charging cost of the slave vehicle, and the master vehicle may selectively allow only a vehicle with a predetermined number of points or more to access. At this time, the power charging cost may be billed to the slave vehicle in such a way a) that the charging service provider bills the power charging cost separately to the master vehicle and the slave vehicle for settling payment, b) that the charging service provider bills the power charging cost separately to the slave vehicle, pays the power charging cost of the slave vehicle to the master vehicle, and bills the entire charge to the master vehicle, or c) that the charging service provider bills the power charging cost only to the master vehicle and the master vehicle bills, to the slave vehicle, the power charging cost to the slave vehicle.

Meanwhile, the authentication unit 240 may authenticate the vehicle through a block chain or in such a way of receiving information on the authentication performed by the charging service provider through the communication unit 270.

It may also be possible for the authentication unit 240 to record an image by means of a built-in cam, a surround view monitoring system, etc. during the power charging, thereby preventing an accident that may occur in the course of a charging attempt.

The battery 250 stores power for driving a motor or charging another vehicle.

The control unit 260 controls power conversion of the power conversion unit 220 and charging of the battery 250.

The communication unit 270 is responsible for communication with the charging service provider server and other vehicles such as a charging master vehicle or a charging slave vehicle. Here, the communication unit 270 may include a wired/wireless communication module that provides wired/wireless communication such as programmable logic controller (PLC), controller area network (CAN), long-term evolution (LTE), and 5th generation (5G). The communication unit 270 may also communicate or interoperate with a user terminal such as a smartphone to receive information set by the user such as whether to allow charging to another vehicle, a charging provision time, and a power charging cost setting and to send information such as charging cost to the user terminal. For example, the communication unit 270 may communicate with a user terminal in order for the user to check, using an app installed in the user terminal, a charging master vehicle capable of V2V charging and a charging cost as a charging slave vehicle or to designate a power supply time available and a power supply cost for a charging slave vehicle as a charging master vehicle.

The display unit 280 provides an interface for user input such as whether to allow charging to other vehicles through audio video navigation (AVN), available charging time, power charging cost setting, etc. or indicates, by means of an LED lamp, that the power output terminal 230 is allowed for connection for charging an unspecified number of vehicles. For example, the display unit 280 may communicate with a user terminal in order for the user to check, using an app installed in the user terminal, a charging master vehicle capable of V2V charging and a charging cost as a charging slave vehicle or to designate a power supply time available and a power supply cost for a charging slave vehicle as a charging master vehicle.

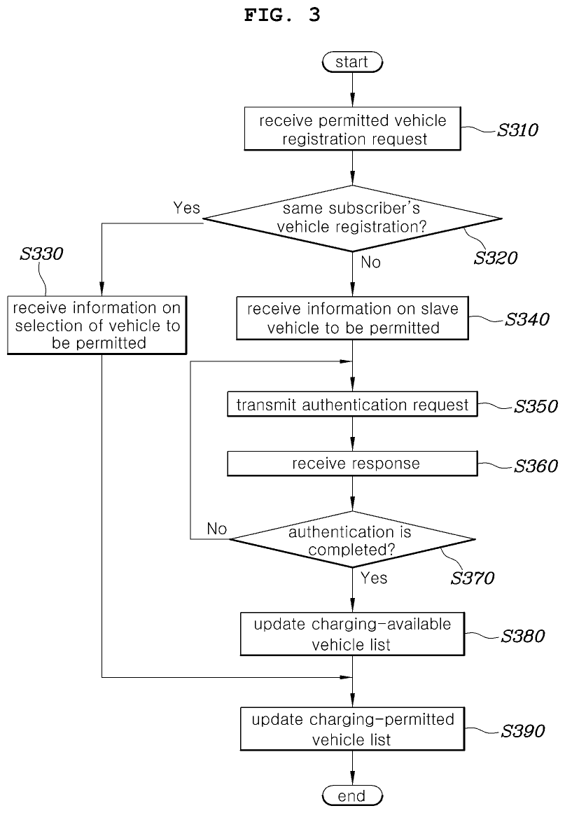

FIG. 3 is a flowchart illustrating an operation sequence of a server for registering a slave vehicle in a charging-permitted vehicle list of a master vehicle in response to a user request in the master vehicle according to an embodiment of the present invention. This embodiment may be applied to a case of using the vehicle-specific permission method among authentication methods that can be performed by the authentication unit 240 of FIG. 2.

With reference to FIG. 3, the server receives at step S310 a registration request for a slave vehicle to be allowed for power charging in the master vehicle from the user terminal of the master vehicle owner. The terminal may be one of various terminals including a smart phone, a portable terminal, a mobile terminal, a foldable terminal, a personal digital assistant (PDA), a portable multimedia player (PMP) terminal, a telematics terminal, a navigation terminal, a personal computer (PC), a laptop computer, a slate PC, a tablet PC, an ultrabook, a wearable device (including a watch-type terminal (Smartwatch), a glass-type terminal (Smart Glass), and a Head Mounted Display (HMD)), a Wibro terminal, an internet protocol television (IPTV) terminal, a smart TV, a digital broadcasting terminal, an audio video navigation (AVN) terminal, an audio/video (A/V) system, a flexible terminal, and a digital signage device. Here, the information exchange between the server and the terminal may be performed via an app, an Internet browser, or the like that is installed in the terminal.

The server also determines at step S320 whether the registration request received at step S310 is a request for vehicle registration of the same subscriber and receives at step S330, when the request is of the vehicle registration of the same subscriber, information on selection of a vehicle to be allowed from the terminal. At step S320, the server may determine whether the registration request is a request for vehicle registration of the same subscriber through a process of transmitting a query to the terminal to confirm whether it is a registration request for a vehicle owned by the user and receiving a response thereto. At step S330, the server may also provide an interface for the user to select a vehicle from a list of vehicles owned by the user, which is transmitted from the server to the terminal and displayed on the display screen of the terminal, and receive, when the terminal transmit information on the vehicle is selected by the user from the list, the vehicle selection information from the terminal.

The server updates, at step S390, the charging-permitted vehicle list of the master vehicle by adding the selected vehicle to the list based on the information on the selection of the vehicle to be permitted that is received at step S330.

Here, the charging-permitted vehicle list may be stored in one or more storage media of the server, the master vehicle, or the terminal of a master vehicle user.

Meanwhile, if it is determined at step S320 that the registration request is not a request for vehicle registration of the same subscriber, the server receives, at step S340, the information on the slave vehicle, to be allowed for charging from the master vehicle, from the terminal. Here, the information on the slave vehicle to be allowed for charging may be one of an ID, a phone number, and a vehicle number of the user who owns the slave vehicle.

The server transmits, at step S350, a request for authentication to the terminal of the slave vehicle user based on the vehicle information received at step S340 and receives a response thereto at step S360. The server determines at step S370 whether the authentication is normally completed based on the response received at step S360, updates at step S380, if it is determined that the authentication is normally completed, a charging-available vehicle list of the slave vehicle by adding the master vehicle to the list, and updates at step S390 the charging-permitted vehicle list of the master vehicle by adding the slave vehicle to the list.

Here, the charging-available vehicle list of the slave vehicle may be stored in one or more storage media of the server, the slave vehicle, or the terminal of a slave vehicle user.

Meanwhile, if it is determined at step S370 that the authentication is not normally completed, the server may re-transmit, at step S350, the request for authentication to the terminal of the slave vehicle user and re-receive the response thereto at step S360.

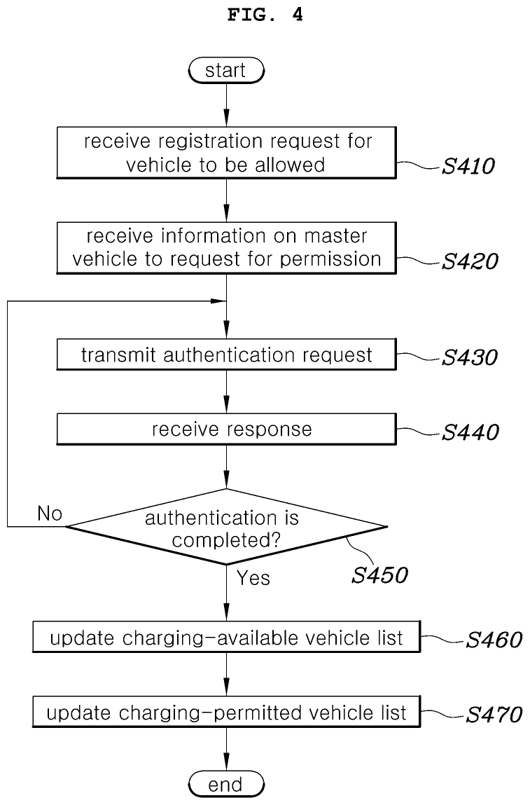

FIG. 4 is a flowchart illustrating an operation sequence of a server for registering a slave vehicle in a permitted vehicle list of a master vehicle in response to a user request of the slave vehicle according to an embodiment of the present invention. This embodiment may be applied to a case of using the vehicle-specific permission method among authentication methods that can be performed by the authentication unit 240 of FIG. 2.

With reference to FIG. 4, the server receives at step S410 a registration request for a slave vehicle to be allowed for power charging in the master vehicle from the user terminal of the master vehicle owner.

Also, the server receives, at step S420, information on the vehicle to request permission from the user terminal of the slave vehicle. Here, the information on the vehicle to request permission may be one of an ID, a phone number, and a vehicle number of the user who owns the master vehicle.

The server transmits, at step S430, a request for authentication to the terminal of the master vehicle user based on the vehicle information received at step S420 and receives a response thereto at step S440. The server determines at step S450 whether the authentication is normally completed based on the response received at step S440, updates at step S460, if it is determined that the authentication is normally completed, a charging-available vehicle list of the slave vehicle by adding the master vehicle to the list, updates at step S470 the charging-permitted vehicle list of the master vehicle by adding the slave vehicle to the list.

Here, the charging-available vehicle list of the slave vehicle may be stored in one or more storage media of the server, the slave vehicle, or the terminal of a slave vehicle user.

Also, the charging-permitted vehicle list of the master vehicle may be stored in one or more storage media of the server, the master vehicle, or the terminal of a master vehicle user.

Meanwhile, if it is determined at step S450 that the authentication is not normally completed, the server may re-transmit, at step S430, the request for authentication to the terminal of the slave vehicle user and re-receive the response thereto at step S440.

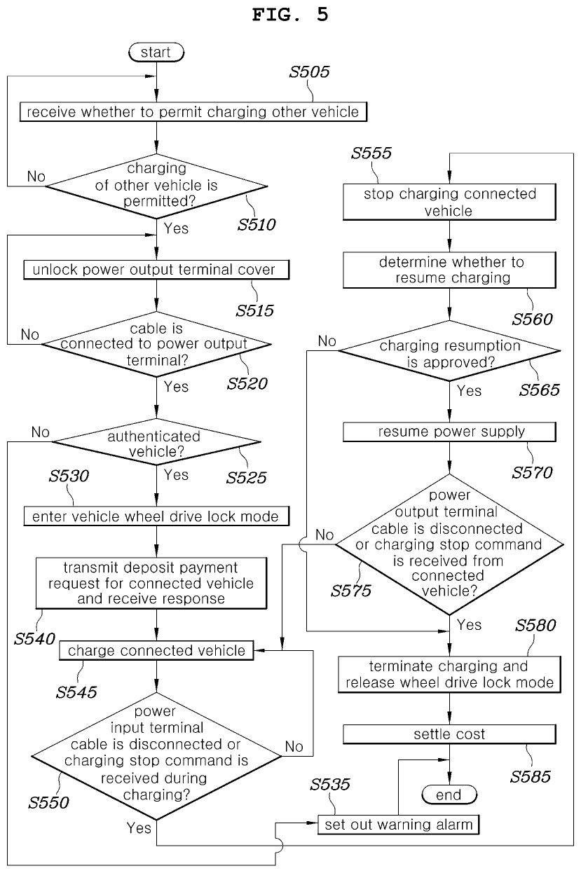

FIG. 5 is a flowchart illustrating an operation sequence of a master vehicle for sharing charging power according to another embodiment of the present invention. This embodiment may be applied to a case of using the all-permissive mode among the authentication modes that can be performed by the authentication unit 240 of FIG. 2.

With reference to FIG. 5, the master vehicle may receive, at step S505, a signal on whether to permit charging of other vehicles and an allowed charging time from the user. Here, the information on whether to permit charging of other vehicles and the permitted time may be received from the server or the terminal of the master vehicle user.

The master vehicle also determines at step S510 whether charging of another vehicle is currently permitted and, if it is determined that charging of other vehicles is permitted, unlocks, at step S515, the power output terminal cover and displays that the master vehicle is currently in a charging-permit state. In this case, it may be possible to indicate that the master vehicle is currently in the charging-permit state by turning on an LED lamp at one side of the power output terminal cover. It may also be possible to transmit information on the specifications of vehicles being chargeable and the charging-available time to the terminal of the master vehicle user and display the corresponding information on the display screen of the terminal.

The master vehicle also determines at step S520 whether a cable is connected to a power output terminal and, if so, determines at step S525 whether the vehicle connected via the cable is an authenticated vehicle.

Here, whether the vehicle is an authenticated vehicle may be determined based on whether the vehicle is subscribed to the platform of the charging service provider or whether the vehicle is capable of using the charging service. It may also be possible to determine whether the vehicle is capable of using the charging service based on the grade of the subscriber.

The master vehicle may also determine whether the connected vehicle is an authenticated vehicle in such a way of transmitting information on the vehicle connected to the power output terminal via the cable to the server and receiving the authentication result from the server.

If it is determined at step S525 that the vehicle connected via the cable is an authenticated vehicle, the master vehicle enters a vehicle wheel drive lock mode. In the vehicle wheel drive lock mode, the vehicle may be set such that the gear of the vehicle is locked in order to prevent the driver from shifting to drive (D) or reverse (R) or the vehicle does not move even if the driver steps on the accelerator.

Meanwhile, if it is determined at step S525 that the vehicle connected via the cable is not an authenticated vehicle, the master vehicle may set off a warning alarm at step S535 and end all operations of power sharing.

In this case, the warning alarm may be set off by turning on an LED lamp on the power output terminal cover or letting off a warning sound through an external speaker.

The master vehicle transmits a deposit payment request for the power charging cost of the vehicle connected through the power output terminal and receives a response thereto at step S540. In this case, the master vehicle may transmit the payment request to the platform server provided by the charging service provider and receive a result of the payment request in response thereto. Meanwhile, the user of the connected vehicle may prepay the charging cost through the platform provided by the charging service provider and receive information on the completion of payment from the platform server in response thereto.

Here, the deposit may be paid to the charging service provider or the owner of the master vehicle.

The master vehicle also charges, at step S545, the vehicle connected via the power output terminal, i.e., the slave vehicle.

The master vehicle also determines at step S550 whether the power input terminal cable connected to the charging station is disconnected or a charging stop command is received from the user terminal of the master vehicle and, if it is determined that the cable is disconnected or the charging stop command is received, stops, at step S555, charging and determines at step S560 whether to resume charging. Here, it may be possible to determine whether to resume power supply in such a way of transmitting a query to the user terminal and receiving a response thereto.

Meanwhile, if it is determined at step S550 that the cable is disconnected or no charging stop command is received, charging the connected vehicle continues at step S545.

The master vehicle also determines at step S565 whether charging resumption is approved by the user and, if the charging resumption is approved, resumes charging at step S570.

Meanwhile, if it is determined at step S565 that charging resumption is not approved, the master vehicle terminates charging and releases the wheel drive lock mode at step S580 and settles the power charging cost at step S585.

The master vehicle also determines at step S575 whether the power output terminal cable is disconnected or a charging stop command is received from the vehicle connected through the cable, i.e., the slave vehicle and, if it is determined that the cable is disconnected or the charging stop command is received from the slave vehicle, terminates charging and releases the wheel drive lock mode at step S580 and settles the power charging cost at step S585.

Here, the settlement of the charge at step S585 may be performed at the server, and the vehicle may transmit/receive information with the server or other vehicles in order for the server to normally perform the settlement of the charge.

Hereinafter, descriptions are made of the type of information communicated between the vehicle and the server or other vehicles and the information communication method.

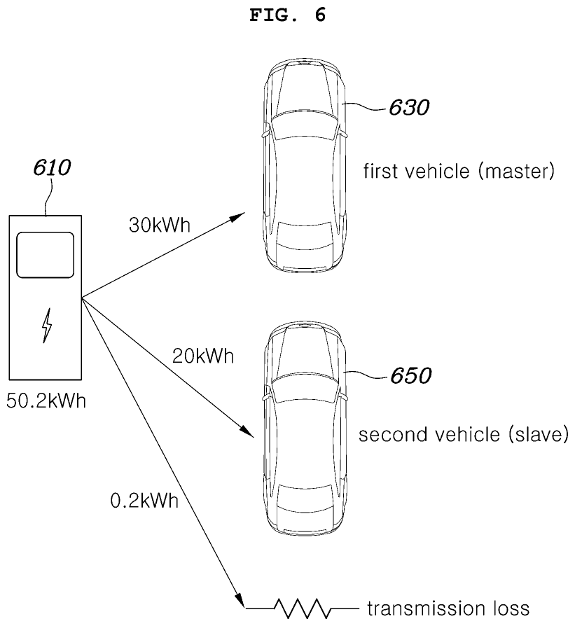

FIG. 6 illustrates an example in which charging power is shared according to an embodiment of the present invention.

With reference to FIG. 6, the first vehicle 630 may be connected to the charger 610 via a charging cable for battery charging, and the second vehicle 650 may be connected to the first vehicle 630 via a charging cable to receive power for battery charging.

Here, it may be possible to assume that the first and second vehicles 630 and 65o receiving power from the charger 610 are respectively charged with 30 kWh and 20 kWh with the occurrence of a transmission loss of 0.2 kWh. In this case, the cost for charging the first and second vehicles 630 and 650 with the power generated from the charger 610 may be charged separately in a shared manner as shown in Table 1 below.

TABLE 1

| | Capacity | Charge | Charging rate | |
|---|---|---|---|---|
| Category | (kWh) | (Won) | (Won/kWh) | Note |
| Charger | 50.2 | 10,040 | 200 | 200 Won/kWh standard |
| | | | | charging rate |
| First vehicle | 30 | 5,700 | 190 Won/kWh | |
| Second | 20 | 4,400 | 220 Won/kWh | Transmission loss + |
| vehicle | | | | Incentive charge for |
| | | | | vehicle A |

With reference to Table 1, although the standard charging rate in the charging infrastructure is 200 won per 1 kWh, it may be possible to make the charge to the sharing-allowing first vehicle with a discounted rate of 190 won per 1 kHw by granting an incentive for sharing power and to the sharing-allowed second vehicle with a raised rate of 220 won per 1 kHw by imposing the burden of the transmission loss and the incentive to the first vehicle 630.

Meanwhile, with reference to FIG. 2, in the case where the authentication unit 240 permits an unspecified vehicle to access the power output terminal of the master vehicle, the power charging cost may be billed in such a way a) that the charging service provider bills the power charging cost separately to the master vehicle and the slave vehicle for settling payment, b) that the charging service provider bills the power charging cost separately to the slave vehicle, pays the power charging cost of the slave vehicle to the master vehicle, and bills the entire charge to the master vehicle, or c) that the charging service provider bills the power charging cost only to the master vehicle and the master vehicle bills, to the slave vehicle, the power charging cost of the slave vehicle.

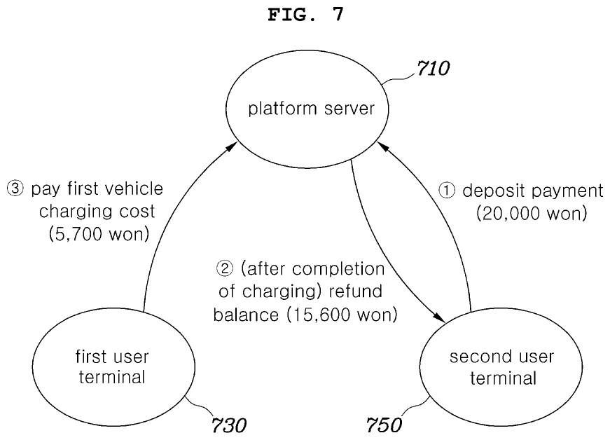

Descriptions are made hereinafter of a charged power billing method and a settlement method in a power supplier platform server according to a), b), and c) with reference to FIGS. 7 to 12.

FIG. 7 conceptually illustrates a method of billing a power charging cost according to an embodiment of the present invention. FIG. 7 may correspond to a) where the charging service provider bills the power charging cost separately to the master and slave vehicles.

Each billing information may be communicated between the server and the terminals of the users who own the respective vehicles in order for the respective vehicle users to pay the bill by means of the terminals. Here, the terminal of the user who owns the first vehicle may be defined as a first user terminal, and the terminal of the user who owns the second vehicle may be defined as a second user terminal. Meanwhile, actual payment or refund payment for each bill is made through each user's credit card or account, but information on the payment may be communicated between the server and the terminals after the actual payment or refund payment is made. Accordingly, in this specification, the description is made in such a way that a refund or payment is made between the server and user terminals for convenience.

With reference to FIG. 7, the platform server 710 receives a deposit, e.g., 20,000 won, in advance for the power charging cost from the second user terminal 750 and refunds the balance remaining after covering the charged power cost. Here, the platform server 710 may charge 5,700 won and 4,400 won to the first and second vehicles, respectively, as shown in Table 1. Accordingly, the platform server 710 may refund the balance of 15,600 won to the second user terminal 750.

The platform server 710 may also receive a payment of 5,700 won as the charging cost of the first vehicle from the first user terminal 730.

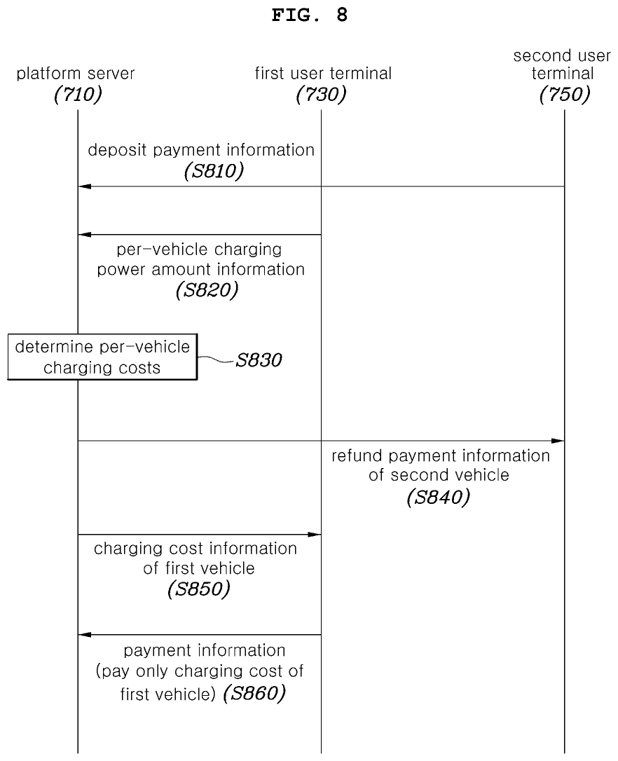

FIG. 8 illustrates a signal transmission/reception operation sequence between a server and terminals for billing according to the embodiment of FIG. 7. The first user terminal 730 of FIG. 8 may correspond to the master vehicle of FIG. 5, and some operations in FIG. 8 may be performed at the cost settlement step of S585 in FIG. 5.

With reference to FIG. 8, the platform server 710 receives, at step S810, deposit payment information from the second user terminal 750.

Here, the deposit payment information may be the information indicating that the owner of the second vehicle has completed a deposit payment by means of the second user terminal 750.

The platform server 710 also receives, at step S820, per-vehicle charging power amount information from the first user terminal 730.

The platform server 710 also determines, at step S830, per-vehicle charging costs based on the per-vehicle charging power amount information received from the first user terminal 730 and preset per-vehicle power charging rates.

The platform server 710 also transmits, at step S840, refund payment information of the second vehicle to the second user terminal 750.

Here, the refund payment information may be information indicating that the platform server 710 paid, to the account of the owner of the second vehicle, the balance between the deposit and the power charging cost of the second vehicle as a refund payment.

The platform server 710 also transmits, at step S850, the charging cost information of the first vehicle to the first user terminal 730.

The first user terminal 730 also transmits, at step S860, the charged power payment information of the first vehicle to the platform server 710.

Here, the charged power payment information may be the information indicating that the owner of the first vehicle paid the charging cost of the first vehicle by means of the first user terminal 730.

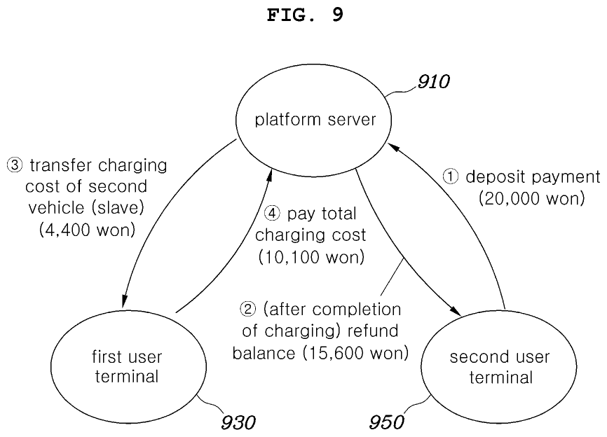

FIG. 9 conceptually illustrates a method of billing a power charging cost according to another embodiment of the present invention. FIG. 9 may correspond to b) where the charging service provider separately bills the power charging cost to the slave vehicle, pays the power charging cost of the slave vehicle to the master vehicle, and bills the entire power charging cost to the master vehicle.

With reference to FIG. 9, the platform server 910 receives a deposit, e.g., 20,000 won, in advance for the power charging cost from the second user terminal 950 and refunds the balance remaining after covering the charged power cost. Here, the platform server 910 may charge 5,700 won and 4,400 won to the first and second vehicles, respectively, as shown in Table 1. Accordingly, the platform server 910 may refund the balance of 15,600 won to the second user terminal 950.

The platform server 910 may also pay 4,400 won as the power charging cost of the second vehicle to the first user terminal 930 in advance and receive the payment of the total power charging cost of 10,100 won for the first and second vehicles from the first user terminal 930.

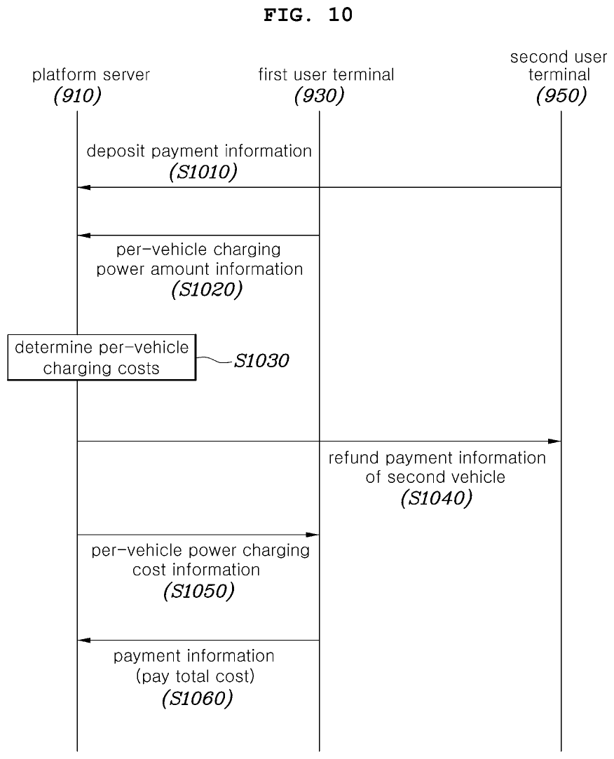

FIG. 10 illustrates a signal transmission/reception operation sequence between a server and terminals for billing according to the embodiment of FIG. 9. The first user terminal 930 of FIG. 10 may correspond to the master vehicle of FIG. 5, and some operations of the first user terminal 930 in FIG. 10 may be performed at the cost settlement step of S585 in FIG. 5.

With reference to FIG. 10, the platform server 910 receives, at step S1010, deposit payment information from the second user terminal 950.

Here, the deposit payment information may be the information indicating that the owner of the second vehicle has completed a deposit payment by means of the second user terminal 950.

The platform server 910 also receives, at step S1020, per-vehicle charging power amount information from the first user terminal 930.

The platform server 910 also determines, at step S1030, per-vehicle charging costs based on the per-vehicle charging power amount information received from the first user terminal 930 and preset per-vehicle power charging rates.

The platform server 910 also transmits, at step S1040, refund payment information of the second vehicle to the second user terminal 950.

Here, the refund payment information may be information indicating that the platform server 910 paid, to the account of the owner of the second vehicle, the balance between the deposit and the power charging cost of the second vehicle as a refund payment.

The platform server 910 also transmits, at step S1050, per-vehicle power charging payment information to the first user terminal 930.

Here, the per-vehicle power charging cost information may include information indicating that the platform server 910 has completed the payment of the power charging cost of the second vehicle to the account of the owner of the first vehicle.

The first user terminal 930 also transmits, at step S1060, the charged power payment information of the first vehicle to the platform server 910.

Here, the charged power payment information may be the information indicating that the owner of the first vehicle paid the charging cost of the first vehicle and the second vehicle by means of the first user terminal 930.

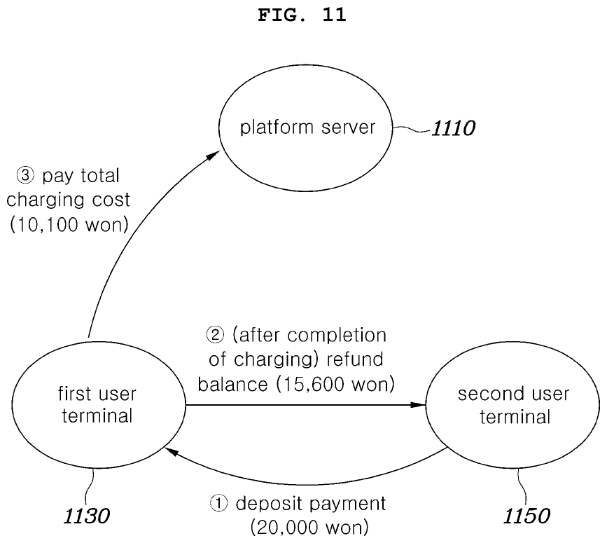

FIG. 11 conceptually illustrates a method of billing a power charging cost according to another embodiment of the present invention. FIG. 11 may correspond to c) where the charging service provider bills the power charging cost only to the master vehicle and the master vehicle bills, to the slave vehicle, the power charging cost of the slave vehicle.

With reference to FIG. 1i, the first user terminal 1130 receives a deposit, e.g., 20,000 won, in advance for the power charging cost from the second user terminal 1150 and refunds the balance remaining after covering the charged power cost. Here, the platform server 1110 may charge 5,700 won and 4,400 won to the first and second vehicles, respectively, as shown in Table 1. Accordingly, the first user terminal 1130 may refund the balance of 15,600 won to the second user terminal 1150.

The platform server 1110 may also receive a payment of 10,100 won as the total power charging cost of the first and second vehicles from the first user terminal 1130.

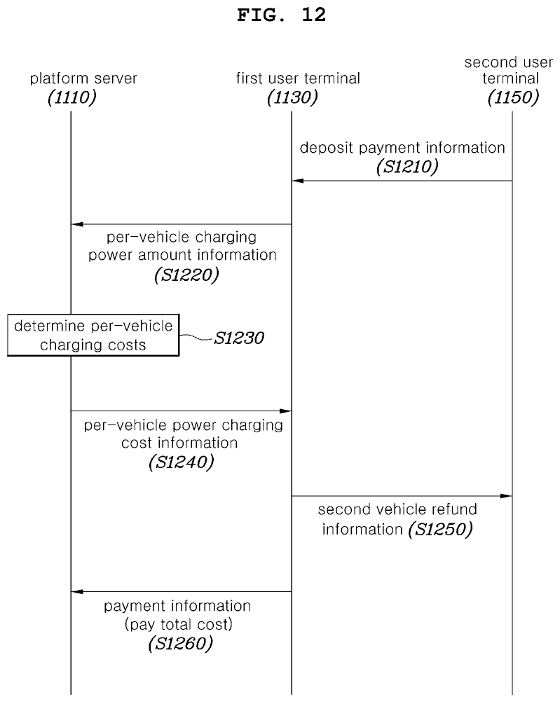

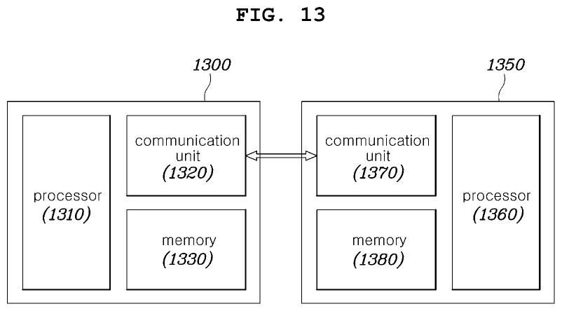

FIG. 12 illustrates a signal transmission/reception operation sequence between a server and terminals for billing according to the embodiment of FIG. 1i. The first user terminal 1130 of FIG. 12 may correspond to the master vehicle of FIG. 5, and some operations of the first user terminal 1130 in FIG. 12 may be performed at the charge settlement step of S585 in FIG. 5.

With reference to FIG. 12, the first user terminal 1130 receives, at step S1210, deposit payment information from the second user terminal 1150.

Here, the deposit payment information may be the information indicating that the owner of the second vehicle has completed a deposit payment to the owner of the first vehicle by means of the second user terminal 1150.

The platform server 1110 also receives, at step S1220, per-vehicle charging power amount information from the first user terminal 1130.

The platform server 1110 also determines, at step S1230, per-vehicle charging costs based on the per-vehicle charging power amount information received from the first user terminal 1130 and preset per-vehicle power charging rates.

The platform server 1110 also transmits, at step S1240, per-vehicle power charging cost information to the first user terminal 1130.

The first user terminal 1130 also transmits, at step S1250, refund payment information of the second vehicle to the second user terminal 1150.

Here, the refund payment information may be information indicating that the owner of the first vehicle paid, to the account of the owner of the second vehicle, the balance between the deposit and the power charging cost of the second vehicle as a refund payment by means of the first user terminal 1130.

The first user terminal 1130 also transmits, at step S1260, the charged power billing information of all the vehicles to the platform server 1110.

Here, the charged power billing information may be the information indicating that the owner of the first vehicle paid the charging cost of the first and second vehicles by means of the first user terminal 1260.

FIG. 13 is a block diagram illustrating a power sharing system of a vehicle according to an embodiment of the present invention.

With reference to FIG. 13, the server 1300 includes a processor 1310, a communication unit 1320, and a memory 1330.

The processor 1310 implements the vehicle power sharing system and/or method proposed in embodiments described in this specification. In detail, the processor 1310 implements all operations of the server described in the embodiments disclosed in this specification and performs all the operations of the platform server in FIGS. 8, 10, and 12.

For example, the processor 1310 may determine power charging cost per vehicle. The communication unit 1320 is connected to the processor 1310 and transmits and/or receives information required for vehicle power sharing. For example, the communication unit 1320 may receive deposit payment information from the terminal, receive per-vehicle charging power amount information from the terminal, transmit refund payment information to the terminal, transmit power charging cost information to the terminal, and receive charged power payment information from the terminal.

The memory 1330 may be various kinds of volatile or non-volatile storage media. Here, the memory 1330 may store at least one of deposit payment information, per-vehicle charging power amount information, refund payment information, per-vehicle charged power cost information, and charged power payment information.

Also, the terminal 1350 includes a processor 1360, a communication unit 1370, and a memory 1380.

The processor 1360 implements the vehicle power sharing system and/or method proposed in embodiments described in this specification. In detail, the processor 1310 implements all operations of the terminal described in the embodiments disclosed in the present specification and performs all operations of the master vehicle, the first user terminal, or the second user terminal in FIGS. 3, 4, 5, 8, 10, and 12.

The communication unit 1370 is connected to the processor 1360 and transmits and/or receives information required for vehicle power sharing. For example, the communication unit 1370 may transmit deposit payment information to the server, transmit per-vehicle charging power amount information to the server, receive refund payment information from the server, receive power charging cost information from the server, and transmit charged power payment information to the server.

The memory 1380 may be various kinds of volatile or non-volatile storage media. Here, the memory 1380 may store at least one of deposit payment information, per-vehicle charging power amount information, refund payment information, per-vehicle charged power cost information, and charged power payment information.

According to the above-described embodiments of the present invention, it may be possible to achieve the lock-in effect by expanding the function of the electric vehicle.

It may also be possible to simultaneously charge a plurality of vehicles greater in number than the chargers installed in an apartment complex or shopping mall of a large city with an underdeveloped charging infrastructure environment.

It may also be possible to contribute to the promotion of a personal power transaction and the creation of a new business model of a parking/charging service.

It may also be possible to increase the demand for eco-friendly vehicles to contribute to society by sharing battery charging terminals.

Meanwhile, embodiments of the present invention described above may be implemented as computer-readable codes on a medium on which a program is recorded. Computer-readable media include all types of recording devices in which data readable by a computer system are stored. Examples of the computer-readable media include a hard disk drive (HDD), a solid state disk (SSD), a silicon disk drive (SDD), a ROM, a RAM, a CD-ROM, a magnetic tape, a floppy disk, an optical data storage device, etc. Accordingly, the above detailed description should not be construed as restrictive in all respects but as exemplary. The scope of the present invention should be determined by a reasonable interpretation of the appended claims and includes all modifications within the equivalent scope of the present invention.

What is claimed is:

1. A power sharing method of a vehicle, the method comprising:
electrically connecting the vehicle to an external charger;
determining whether a second vehicle connected to a power output terminal of the vehicle via a cable is an authenticated vehicle;
in response to a determination that the second vehicle is an authenticated vehicle, transmitting a request for the second vehicle to a server;
receiving a response to the request from the server;
charging power to the second vehicle; and
communicating information with the server or the second vehicle, the information related to the power charged to the vehicle and the second vehicle.

2. The method of claim 1, wherein communicating the information with the server or the second vehicle comprises:
transmitting charged power amount information of the vehicle and the second vehicle to the server;
receiving charged power cost information of the vehicle from the server; and
transmitting charged power cost payment information of the vehicle to the server.

3. The method of claim 1, wherein communicating the information with the server or the second vehicle comprises:
transmitting charged power amount information of the vehicle and the second vehicle to the server;
receiving charged power cost information of the vehicle and the second vehicle from the server; and
transmitting charged power cost payment information of the vehicle and the second vehicle to the server.

4. The method of claim 1, wherein communicating the information with the server or the second vehicle comprises:
receiving deposit payment information from the second vehicle;
transmitting charged power amount information of the vehicle and the second vehicle to the server;
receiving charged power cost information of the vehicle and the second vehicle from the server;
transmitting refund payment information to the second vehicle; and
transmitting charged power cost payment information of the vehicle to the server.

5. The method of claim 2, wherein the costs of the power charged to the vehicle and the second vehicle are determined at different rates.

6. The method of claim 1, wherein determining whether the second vehicle is the authenticated vehicle comprises determining whether the second vehicle is the authenticated vehicle based on whether the second vehicle is subscribed to a platform of a charging service provider or whether the second vehicle is capable of using a charging service.

7. The method of claim 1, further comprising:
entering a vehicle wheel drive lock mode before charging the second vehicle; and
releasing the vehicle wheel drive lock mode after charging the second vehicle is finished.

8. The method of claim 1, further comprising:
receiving from a user whether to permit charging the second vehicle and an allowed charging time;
determining whether the second vehicle is currently permitted for charging; and
in response to a determination that the second vehicle is currently permitted for charging, unlocking the power output terminal cover and displaying that the vehicle is currently in a chargeable state.

9. The method of claim 1, further comprising, in response to a determination that the second vehicle is not the authenticated vehicle, setting off a warning alarm and stopping power sharing.

10. The method of claim 1, further comprising:
determining whether a power input terminal cable connected to a charging station is disconnected or a charging stop command is received from a user terminal;
in response to a determination that the power input terminal cable is disconnected or the charging stop command is received, stopping charging the second vehicle;
determining whether to resume charging the second vehicle; and
resuming or ending charging based on a result of a determination of whether resuming charging the second vehicle is approved.

11. A vehicle capable of sharing power from an external charger with a second vehicle, the vehicle comprising:
a power input terminal;
a power output terminal;
a processor configured to determine whether the second vehicle connected to the power output terminal via a cable is an authenticated vehicle and to cause the second vehicle to be charged in response to a determination that the second vehicle is the authenticated vehicle; and
a communication unit configured to:
transmit to a server a request related to power charging of the second vehicle;
receive a response to the request from the server; and
communicate information with the server or the second vehicle, the information related to power charged to the vehicle and the second vehicle.

12. The vehicle of claim 11, wherein the communication unit is configured to transmit charged power amount information of the vehicle and the second vehicle to the server, receive charged power cost information of the vehicle from the server, and transmit charged power cost payment information of the vehicle to the server.

13. The vehicle of claim 11, wherein the communication unit is configured to transmit charged power amount information of the vehicle and the second vehicle to the server, receive charged power cost information of the vehicle and the second vehicle from the server, and transmit charged power cost payment information of the vehicle and the second vehicle to the server.

14. The vehicle of claim 11, wherein the communication unit is configured to receive deposit payment information from the second vehicle, transmit charged power amount information of the vehicle and the second vehicle to the server, receive charged power cost information of the vehicle and the second vehicle from the server, transmit refund payment information to the second vehicle, and transmit charged power cost payment information of the vehicle and the second vehicle to the server.

15. The vehicle of claim 12, wherein the costs of the power charged to the vehicle and the second vehicle are determined at different rates.

16. The vehicle of claim 11, wherein the processor is configured to determine whether the second vehicle is the authenticated vehicle based on whether the second vehicle is subscribed to a platform of a charging service provider or whether the second vehicle is capable of using a charging service.

17. The vehicle of claim 11, wherein the processor is configured to control the vehicle to enter a wheel drive lock mode before charging the second vehicle and release the wheel drive lock mode after charging the second vehicle is finished.

18. The vehicle of claim 11, wherein:
the communication unit is configured to receive from a user whether to permit charging of the second vehicle and an allowed charging time; and
the processor is configured to determine whether the second vehicle is currently permitted for charging and, in response to a determination that the second vehicle is currently permitted for charging, to unlock the power output terminal cover and display that the vehicle is currently in a chargeable state.

19. The vehicle of claim 11, wherein, in response to a determination that the second vehicle is not the authenticated vehicle, the processor is configured to control the vehicle to set off a warning alarm and stop power sharing.

20. The vehicle of claim 11, wherein the processor is configured to:
determine whether a power input terminal cable connected to a charging station is disconnected or a charging stop command is received from a user;
in response to a determination that the power input terminal cable is disconnected or the charging stop command is received, control to stop charging the second vehicle; and
resume or end charging of the second vehicle based on a determination of whether resuming charging of the second vehicle is approved.
